(19) United States
(12) Patent Application Publication
(10) Pub. No.: US 2023/0365845 A1
(43) Pub. Date: Nov. 16, 2023

(54) ONE-COMPONENT STRUCTURAL ADHESIVE

(71) Applicant: DDP SPECIALTY ELECTRONIC MATERIALS US, LLC, Wilmington, DE (US)

(72) Inventors: Andreas Lutz, Freienbach (CH); Felix Koch, Freienbach (CH); Jeannine Flueckiger, Freienbach (CH)

(21) Appl. No.: 18/033,534

(22) PCT Filed: Aug. 18, 2021
(86) PCT No.: PCT/US2021/046496

§ 371 Date: Apr. 24, 2023

Related U.S. Application Data
(60) Provisional application No. 63/105,391, filed on Oct. 26, 2020.

(51) Int. Cl. C09J 163/00; C08G 18/48; C08G 18/28; C08G 18/24; C08G 18/73; C08G 18/32; B32B 7/12

(52) U.S. Cl. CPC C09J 163/00; C08G 18/4854; C08G 18/2825; C08G 18/246; C08G 18/73; C08G 18/3215; B32B 7/12

(57) ABSTRACT

Provided herein is a one-component adhesive composition showing excellent adhesive strength after heat and humidity exposure.

### FIELD OF INVENTION

The present invention relates to the field of one-component epoxy adhesives, particularly toughened epoxy adhesives showing good ageing characteristics under high humidity and elevated temperatures.

### BACKGROUND OF THE INVENTION

Toughened one-component epoxy structural adhesives are used extensively in the automotive and other industries for metal-metal bonding as well as bonding metals to other materials. Often, these structural adhesives must strongly resist failure during vehicle collision situations. Structural adhesives of this type are sometimes referred to as “crash durable adhesives”, or “CDAs”. This attribute is achieved through the presence of certain types of materials in the adhesive formulation. These materials are often referred to as “tougheners”. The tougheners have blocked functional groups that, under the conditions of the curing reaction, can become de-blocked and react with an epoxy resin. Tougheners of this type are described, for example, in U.S. Pat. Nos. 5,202,390, 5,278,257, WO 2005/118734, WO 2007/003650, WO2012/091842, U. S. Published Patent Application No. 2005/0070634, U. S. Published Patent Application No. 2005/0209401, U. S. Published Patent Application 2006/0276601, EP-A-0 308 664, EP 1 498 441A, EP-A 1 728 825, EP-A 1 896 517, EP-A 1 916 269, EP-A 1 916 270, EP-A 1 916 272 and EP-A-1 916 285.

U.S. Pat. No. 9,181,463 describes epoxy-based adhesives comprising a toughener made by reacting a poly(tetramethylene ether)glycol (“PTMEG”), with a diisocyanate, then chain extending the resulting prepolymer with O,O′-diallylbisphenol A, followed by capping of the isocyanate groups with a mono- or di-phenol. Such Adhesives are said to show good storage stability and cure to form cured adhesives that have good lap shear and impact peel strengths.

Adhesives in automotive use are subjected to harsh environmental conditions, in particular elevated temperatures and high humidity. Because of this, automobile manufacturers require adhesives with good strength retention after exposure to heat and humidity.

A need remains for toughened adhesives that show good retention of adhesive strength after exposure to heat and humidity.

### SUMMARY OF THE INVENTION

In a first aspect, provided herein is a one-component epoxy adhesive composition comprising:
A) at least one epoxy resin;
B) from 5 to 16 wt %, based on the total weight of the adhesive, of a reactive toughener made by reacting at least one poly(alkylene oxide)diol and optionally poly(butadiene)diol with a diisocyanate in the presence of a polyurethane catalyst, optionally followed by chain extension with a di-phenol, and end-capping with a mono- or di-phenol;
C) one or more latent epoxy curing agents;
D) one or more epoxy curing catalysts.

In a second aspect, the invention provides a bonded structure comprising:
(1) a first substrate;
(2) a second substrate;
(3) an adhesive composition connecting a portion of the surface of the first and second substrates, wherein the adhesive composition comprises:
A) at least one epoxy resin;
B) from 5 to 16 wt %, based on the total weight of the adhesive, of a reactive toughener made by reacting at least one poly(alkylene oxide)diol and optionally poly(butadiene)diol with a diisocyanate in the presence of a polyurethane catalyst, optionally followed by chain extension with a di-phenol, and end-capping with a mono- or di-phenol;
C) one or more latent epoxy curing agents;
D) one or more epoxy curing catalysts.

### DETAILED DESCRIPTION OF THE INVENTION

The inventors have surprisingly found that by decreasing the toughener content in an epoxy adhesive, adhesive performance after heat and humidity exposure is significantly improved.

### Definitions and Abbreviations

PTMEG poly(tetramethylene oxide) glycol
DGEBA bis-phenol A diglycidyl ether

Molecular weights of polymers as reported herein are reported in Daltons (Da) as number or weight average molecular weights, as determined by size exclusion chromatography (SEC).

Epoxy Resin

Epoxy resins useful in adhesive compositions according to this invention include a wide variety of curable epoxy compounds and combinations thereof. Useful epoxy resins include liquids, solids, and mixtures thereof. Typically, the epoxy compounds are epoxy resins which are also referred to as polyepoxides. Polyepoxides useful herein can be monomeric (e.g., the diglycidyl ether of bisphenol A, diglycidyl ether of bisphenol F, diglycidyl ether of tetrabromobisphenol A, novolac-based epoxy resins, and tris-functional epoxy resins), higher molecular weight resins (e.g., the diglycidyl ether of bisphenol A advanced with bisphenol A) or polymerized unsaturated monoepoxides (e.g., glycidyl acrylates, glycidyl methacrylate, allyl glycidyl ether, etc.) to homopolymers or copolymers. Most desirably, epoxy compounds contain, on the average, at least one pendant or terminal 1,2 epoxy group (i.e., vicinal epoxy group) per molecule. Solid epoxy resins that may be used in the present invention preferably can comprise or preferably be based upon mainly bisphenol A. Some preferred epoxy resins include, for example, D.E.R. 330, D.E.R. 331, and D.E.R. 671, all commercially available from The Dow Chemical Company.

One preferable epoxy resin has general formula:

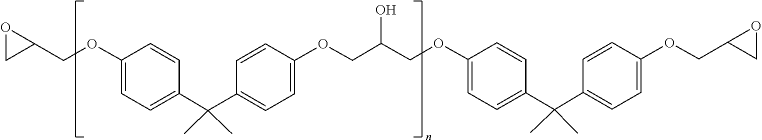

where n is in the range of 0 to about 25.

Preferred epoxy resins have epoxy equivalent weights in the range of about 170 to 195 g/mol.

Combinations of epoxy resins may be used to adjust properties of the epoxy adhesive. In compositions and methods of the present invention, the epoxy adhesive may comprise any amount of epoxy resin. Preferably, the liquid and/or solid epoxy resin comprise more than or about 20 wt %, more preferably more than or about 25 wt %, 30 wt % or 35 wt %, of the epoxy adhesive. Preferably, the liquid and/or solid epoxy resin comprise less than or about 65 wt %, more preferably less than or about 55 wt % or 45 wt %, of the epoxy adhesive. Other preferred amounts are shown in the Examples. Ranges formed from pairs of these values (e.g., 25 to 35 wt %, 25 to 65 wt %, to 38 wt % (adhesive AA)) are also preferred.

When a combination of liquid and solid epoxy resins is used, any proportion can be used, and can be determined by one of ordinary skill in the art. In order to obtain a suitable viscosity, it is generally preferred that the weight proportion of liquid to solid epoxy resin is greater than 50:50. Epoxy adhesive compositions of the present invention preferably comprise liquid and solid epoxy resins in a ratio of, or greater than, 55:45, 65:35, or 70:30. Epoxy adhesive compositions of the present invention preferably comprise liquid and solid epoxy resins in a ratio of, or less than, 100:0, 99:1, 90:10, or 85:10. Other preferred ratios are shown in the Examples. Ranges formed from pairs of these values (e.g. 50:50 to 100:0, 65:35 to 82:18 (adhesive AU)) are also preferred.

Preferred epoxy resins include:
1. A liquid reaction product of epichlorohydrin and bisphenol A, having an epoxide equivalent weight of 170-195 g/eq (as measured according to ASTM D-1652), an epoxide percentage of 22.4-23.6% (as measured according to ASTM D-1652), an epoxide group content of 5200-5500 mmol/kg (as measured according to ASTM D-1652), and a viscosity at 25° C. of 4000-14000 mPas (as measured according to ASTM D-445);
2. A solid epoxy resin is a low molecular weight solid reaction product of epichlorohydrin and Bisphenol-A, having an epoxide equivalent weight of 475-550 g/eq (as measured according to ASTM D-1652), an epoxide percentage of 7.8-9.1% (as measured according to ASTM D-1652), an epoxide group content of 1820-2110 mmol/kg (as measured according to ASTM D-1652), and a melt viscosity at 150° C. of 400-950 mPas (as measured according to ASTM D-4287);
3. Mixtures of 1 and 2.
4. A mixture of 60:40 of epoxy 2:epoxy 1.

Toughener

The adhesive compositions of the invention comprise a toughener at between to 16 wt %, based on the total weight of the composition. The toughener is preferably present at 15 wt % or less, more preferably at 14 wt % or less, or 12 wt % or less, based on the total weight of the adhesive composition.

The tougheners used in the inventive compositions are reactive tougheners made by reacting a poly(alkylene oxide)diol and optionally poly(butadiene)diol (“PBD”) with a diisocyanate in the presence of a polyurethane catalyst, optionally followed by chain extension with a di-phenol, and end-capping with a mono- or di-phenol.

In a preferred embodiment PBD is included.

In another preferred embodiment, chain extension with a di-phenol is carried out.

In another preferred embodiment, PBD is included and chain extension with a di-phenol is carried out.

In another preferred embodiment, PBD is not included.

In another preferred embodiment, chain extension is not carried out.

In another preferred embodiment, PBD is not included and chain extension is not carried out.

Preferred poly(alkylene oxide)diols are selected from poly(C₂-C₆ alkylene oxide) diols, particularly poly(tetramethylene oxide)diol (“PTMEG”), poly(trimethylene oxide)diol (“PO3G”), and mixtures of these. The poly(alkylene oxide)diol preferably has a molecular weight in the range of 1,000 to 2,500 Da, more preferably 2,000 Da. PTMEG is particularly preferred. Preferably, the PTMEG has a molecular weight in the range of 1,000 to 2,500 Da, more preferably 2,000 Da.

The PBD preferably has a molecular weight in the range of 2,000 to 3,500 Da, more preferably 2,800 Da.

The diisocyanate is not particularly limited. Aliphatic diisocyanates are preferred, with 1,6-Hexamethylenediisocyanate (“HMDI”) and isophorone diisocyanate (IPDI) being particular examples. HMDI is particularly preferred.

The polyurethane catalyst is not particularly limited. Dibutyltin dilaurate (“DBTL”) is particularly preferred. The catalyst is preferably used at 0.01 to 0.1 wt %, more preferably 0.6 wt %, based on the total weight of the toughener.

Optional chain extension is carried out with a di-phenol. O,O′-diallylbisphenol A (“ODBA”) is particularly preferred. The di-phenol is preferably used at 2 to 10 wt %, more preferably 5 to 8 wt %, particularly preferably 7 wt %, based on the total weight of the toughener. Alternatively, the chain-extender may be used at a molar ratio to the polyol of from 0:1 to 1:1, more preferably 0:1 to 0.8:1, particularly preferably 0.6:1 to 0.8:1.

End-capping is carried out with a mono- or di-phenol. A particularly preferred mono-phenol is cashew nut shell oil (“CNSL”). The end-capping mono- or di-phenol is preferably used at 5 to 20 wt %, more preferably 10 to 15 wt %, particularly 13 wt %, based on the total weight of the toughener. Alternatively, the end-capping group may be used at a molar ratio to the polyol of from 0.1:1 to 2:1, more preferably 0.2:1 to 1.8:1, more particularly preferably 0.3:1 to 1.7:1.

The toughener preferably contains 40 to 60 wt % poly(alkylene oxide)diol, more preferably 45 to 55 wt %, based on the total weight of the toughener. Particularly preferably the toughener contains 40 to 60 wt % PTMEG, more preferably 45 to 55 wt %, based on the total weight of the toughener, with PTMEG having a molecular weigh of 2,000 Da being particularly preferred.

The toughener preferably contains 10 to 25 wt % PBD, more preferably 12 to 18 wt %, based on the total weight of the toughener, with PBD having a molecular weight of 2,800 Da being particularly preferred.

In a preferred embodiment, the toughener is made by reacting the following components (wt %'s are based on the total weight of the toughener):

| | | |
|---|---|---|
| PTMEG (2,000 Da) | 50.41 | wt % |
| PBD (2,800 Da) | 16.81 | wt % |
| ODBA | 7.09 | wt % |
| HMDI | 12.58 | wt % |
| DBTDL | 0.06 | wt % |
| CNSL | 13.05 | wt % |

The toughener is made by the following process:
1. First reaction step: the poly(alkylene oxide)diol and the PBD are added into a lab reactor and heated up to 120° C. The mixture is heated for 30 minutes at 120° C. under vacuum. The mixture is cooled to 60° C. When the temperature reaches 60° C. the diisocyanate is added and the mixture is mixed for 2 minutes. The polyurethane catalyst is then added and the mixture is allowed to react at 85° C. (bath temperature) for 45 minutes under nitrogen.
2. Second reaction step: the chain extender is added and the mixture is stirred for 60 minutes at 95° C. (bath temperature) under nitrogen.
3. Third reaction step: the end-capping phenol is added and the mixture is stirred for 90 minutes at 95° C. (bath temperature) under nitrogen. The mixture is stirred for 10 minutes at 95° C. under vacuum for degassing.

A particularly preferred toughener is made using the above process using the following components (wt %'s are based on the total weight of the toughener):

| | | |
|---|---|---|
| PTMEG (2,000 Da) | 50.41 | wt % |
| PBD (2,800 Da) | 16.81 | wt % |
| ODBA | 7.09 | wt % |
| HMDI | 12.58 | wt % |
| DBTDL | 0.06 | wt % |
| CNSL | 13.05 | wt % |

Latent Epoxy Curing Agent

The adhesive also contains a latent curing agent. A curing agent is considered to be “latent” for purposes of this invention if the adhesive exhibits a curing temperature of at least 60° C. The curing temperature preferably is at least 80° C., and may be at least 100° C. or at least 140° C. It may be as high as, for example, 180° C. The “curing temperature” refers to the lowest temperature at which the structural adhesive achieves at least 30% of its lap shear strength (DIN ISO 1465) at full cure within 2 hours. The lap shear strength at “full cure” is measured on a sample that has been cured for 30 minutes at 180° C., which conditions represent “full cure” conditions.

Suitable latent curing agents include materials such as boron trichloride/amine and boron trifluoride/amine complexes, melamine, diallylmelamine, guanamines such as dicyandiamide, methyl guanidine, dimethyl guanidine, trimethyl guanidine, tetramethyl guanidine, methylisobiguanidine, dimethylisobiguanidine, tetramethylisobiguandidine, heptamethylisobiguanidine, hexamethylisobiguanidine, acetoguanamine and benzoguanamine, aminotriazoles such as 3-amino-1,2,4-triazole, hydrazides such as adipic dihydrazide, stearic dihydrazide, isophthalic dihydrazide, semicarbazide, cyanoacetamide, and aromatic polyamines such as diaminodiphenylsulphones. Dicyandiamide is a particularly preferred curing agent.

The latent curing agent is used in an amount sufficient to cure the adhesive. Typically, enough of the curing agent is provided to consume at least 80% of the epoxide groups present in the composition. A large excess over that amount needed to consume all of the epoxide groups is generally not needed. Preferably, the curing agent constitutes at least about 1.5 weight percent of the adhesive, more preferably at least about 2.5 weight percent and even more preferably at least 3.0 weight percent thereof. The curing agent preferably constitutes up to about 15 weight percent of the adhesive composition, more preferably up to about 10 weight percent, and most preferably up to 8 weight percent.

In a preferred embodiment, the latent epoxy curing agent is dicyandiamide. The epoxy/dicyandiamide ratio constant (EP/Dicy ratio) is calculated by the ratio of the number of epoxy groups per kg to the number of dicy molecules per kg of the formulation. Preferably the dicyandiamide is present in an amount to give an epoxy/dicyandiamide ratio of about 5. Preferably the dicyandiamide is present in the adhesive at 2 to 8 wt %, more preferably 4 to 5 wt %, based on the total weight of the adhesive composition.

Epoxy Curing Catalyst

The adhesive compositions of the invention comprise an epoxy curing catalyst.

The epoxy curing catalyst is one or more materials that catalyze the reaction of the epoxy resin(s) with the curing agent. It is preferably encapsulated or otherwise a latent type that becomes active only upon exposure to elevated temperatures. Among preferred epoxy catalysts are ureas such as p-chlorophenyl-N,N-dimethylurea (Monuron), 3-phenyl-1,1 dimethylurea (Phenuron), 3,4-dichlorophenylN, N-dimethylurea (Diuron), N-(3 chloro-4-methylphenyl)-N′,N′-dimethylurea 25 (Chlortoluron), tert-acryl- or alkylene amines like benzyldimethylamine, 2,4,6-tris(dimethylaminomethyl)phenol, piperidine or derivatives thereof, various aliphatic urea compounds such as are described in EP1916272; C₁-C₁₂ alkylene imidazole or N-arylimidazoles, such as 2-ethyl-2-methylimidazol, or N-butylimidazole and 6-caprolactam, 2,4,6-tris(dimethylaminomethyl)phenol integrated into a poly(p-vinylphenol) matrix (as described in European patent EP0197892), or 2,4,6-tris(dimethylaminomethyl)phenol integrated into a novolac resin, including those described in U.S. Pat. No. 4,701,378, are suitable. Particularly preferred is tris-2,4,6-tris(dimethylaminomethyl)phenol integrated into a poly(p-vinylphenol) polymer matrix.

The epoxy curing catalyst may constitute, for example, at least 0.1 percent, at least 0.25 percent or at least 0.5 percent of the total weight of the adhesive composition, and may constitute, for example, up to 5 percent, up to 3 percent or up to 2 percent of the total weight of the adhesive composition.

In a preferred embodiment, the epoxy curing catalyst is 2,4,6-tris(dimethylaminomethyl)phenol integrated into a poly(p-vinylphenol) polymer matrix, used at an amount of 0.5 to 1.5 wt %, more preferably 1 wt %, based on the total weight of the adhesive composition.

### Examples of Preferred Adhesive Compositions of the Invention

1. A one-component epoxy adhesive composition comprising:
A) at least one epoxy resin;
B) from 5 to 16 wt %, based on the total weight of the adhesive, of a reactive toughener made by reacting at least one poly(alkylene oxide)diol and poly(butadiene)diol with a diisocyanate in the presence of a polyurethane catalyst, followed by chain extension with a di-phenol, and end-capping with a mono- or di-phenol;
C) one or more latent epoxy curing agents;
D) one or more epoxy curing catalysts.

2. A one-component epoxy adhesive composition comprising:
A) at least one epoxy resin selected from a liquid reaction product of epichlorohydrin and bisphenol A, having an epoxide equivalent weight of 170-195 g/eq (as measured according to ASTM D-1652), an epoxide percentage of 22.4-23.6% (as measured according to ASTM D-1652), an epoxide group content of 5200-5500 mmol/kg (as measured according to ASTM D-1652), and a viscosity at 25° C. of 4000-14000 mPas (as measured according to ASTM D-445), a solid epoxy resin is a low molecular weight solid reaction product of epichlorohydrin and Bisphenol-A, having an epoxide equivalent weight of 475-550 g/eq (as measured according to ASTM D-1652), an epoxide percentage of 7.8-9.1% (as measured according to ASTM D-1652), an epoxide group content of 1820-2110 mmol/kg (as measured according to ASTM D-1652), and a melt viscosity at 150° C. of 400-950 mPas (as measured according to ASTM D-4287), and mixtures of these;
B) from 5 to 16 wt %, based on the total weight of the adhesive, of a reactive toughener made by reacting at least one poly(alkylene oxide)diol and poly(butadiene)diol with a diisocyanate in the presence of a polyurethane catalyst, followed by chain extension with a di-phenol, and end-capping with a mono- or di-phenol;
C) one or more latent epoxy curing agents;
D) one or more epoxy curing catalysts.

3. A one-component epoxy adhesive composition comprising:
A) at least one epoxy resin;
B) from 5 to 16 wt %, based on the total weight of the adhesive, of a reactive toughener made by reacting PTMEG and poly(butadiene)diol with a diisocyanate in the presence of a polyurethane catalyst, followed by chain extension with a di-phenol, and end-capping with a mono- or di-phenol;
C) one or more latent epoxy curing agents;
D) one or more epoxy curing catalysts.

4. A one-component epoxy adhesive composition comprising:
A) at least one epoxy resin;
B) from 5 to 16 wt %, based on the total weight of the adhesive, of a reactive toughener made by reacting PTMEG and poly(butadiene)diol with an aliphatic diisocyanate in the presence of a polyurethane catalyst, followed by chain extension with a di-phenol, and end-capping with a mono- or di-phenol;
C) one or more latent epoxy curing agents;
D) one or more epoxy curing catalysts.

5. A one-component epoxy adhesive composition comprising:
A) at least one epoxy resin;
B) from 5 to 16 wt %, based on the total weight of the adhesive, of a reactive toughener made by reacting PTMEG and poly(butadiene)diol with HMDI in the presence of a polyurethane catalyst, followed by chain extension with a di-phenol, and end-capping with a mono- or di-phenol;
C) one or more latent epoxy curing agents;
D) one or more epoxy curing catalysts.

6. A one-component epoxy adhesive composition comprising:
A) at least one epoxy resin;
B) from 5 to 16 wt %, based on the total weight of the adhesive, of a reactive toughener made by reacting PTMEG and poly(butadiene)diol with an aliphatic diisocyanate in the presence of a polyurethane catalyst, followed by chain extension with ODBA, and end-capping with a mono- or di-phenol;
C) one or more latent epoxy curing agents;
D) one or more epoxy curing catalysts.

7. A one-component epoxy adhesive composition comprising:
A) at least one epoxy resin;
B) from 5 to 16 wt %, based on the total weight of the adhesive, of a reactive toughener made by reacting PTMEG and poly(butadiene)diol with an aliphatic diisocyanate in the presence of a polyurethane catalyst, followed by chain extension with a di-phenol, and end-capping with CNSL;
C) one or more latent epoxy curing agents;
D) one or more epoxy curing catalysts.

8. A one-component epoxy adhesive composition comprising:
A) at least one epoxy resin;
B) from 5 to 16 wt %, based on the total weight of the adhesive, of a reactive toughener made by reacting PTMEG and poly(butadiene)diol with HMDI in the presence of a polyurethane catalyst, followed by chain extension with ODBA, and end-capping with CNSL;
C) one or more latent epoxy curing agents;
D) one or more epoxy curing catalysts.

9. A one-component epoxy adhesive composition comprising:
A) at least one epoxy resin;
B) from 5 to 16 wt %, based on the total weight of the adhesive, of a reactive toughener made by reacting at least one poly(alkylene oxide)diol and poly(butadiene)diol with a diisocyanate in the presence of a polyurethane catalyst, followed by chain extension with a di-phenol, and end-capping with a mono- or di-phenol;
C) one or more latent epoxy curing agents, which is dicyandiamide;
D) one or more epoxy curing catalysts.

10. A one-component epoxy adhesive composition comprising:
A) at least one epoxy resin selected from a liquid reaction product of epichlorohydrin and bisphenol A, having an epoxide equivalent weight of 170-195 g/eq (as measured according to ASTM D-1652), an epoxide percentage of 22.4-23.6% (as measured according to ASTM D-1652), an epoxide group content of 5200-5500 mmol/kg (as measured according to ASTM D-1652), and a viscosity at 25° C. of 4000-14000 mPas (as measured according to ASTM D-445), a solid epoxy resin is a low molecular weight solid reaction product of epichlorohydrin and Bisphenol-A, having an epoxide equivalent weight of 475-550 g/eq (as measured according to ASTM D-1652), an epoxide percentage of 7.8-9.1% (as measured according to ASTM D-1652), an epoxide group content of 1820-2110 mmol/kg (as measured according to ASTM D-1652), and a melt viscosity at 150° C. of 400-950 mPas (as measured according to ASTM D-4287), and mixtures of these;
B) from 5 to 16 wt %, based on the total weight of the adhesive, of a reactive toughener made by reacting PTMEG and poly(butadiene)diol with HMDI in the presence of a polyurethane catalyst, followed by chain extension with ODBA, and end-capping with CNSL;
C) one or more latent epoxy curing agents, which is dicyandiamide; D) one or more epoxy curing catalysts, which is tris-2,4,6-tris(dimethylaminomethyl)phenol embedded into a polyvinylphenol polymer matrix.

11. A one-component epoxy adhesive composition comprising:
A) at least one epoxy resin selected from a liquid reaction product of epichlorohydrin and bisphenol A, having an epoxide equivalent weight of 170-195 g/eq (as measured according to ASTM D-1652), an epoxide percentage of 22.4-23.6% (as measured according to ASTM D-1652), an epoxide group content of 5200-5500 mmol/kg (as measured according to ASTM D-1652), and a viscosity at 25° C. of 11000-14000 mPas (as measured according to ASTM D-445), a solid epoxy resin is a low molecular weight solid reaction product of epichlorohydrin and Bisphenol-A, having an epoxide equivalent weight of 475-550 g/eq (as measured according to ASTM D-1652), an epoxide percentage of 7.8-9.1% (as measured according to ASTM D-1652), an epoxide group content of 1820-2110 mmol/kg (as measured according to ASTM D-1652), and a melt viscosity at 150° C. of 400-950 mPas (as measured according to ASTM D-4287), and mixtures of these;
B) from 5 to 16 wt %, based on the total weight of the adhesive, of a reactive toughener made by reacting:

| | | |
|---|---|---|
| PTMEG (2,000 Da) | 50.41 | wt % |
| PBD (2,800 Da) | 16.81 | wt % |
| ODBA | 7.09 | wt % |
| HMDI | 12.58 | wt % |
| DBTDL | 0.06 | wt % |
| CNSL | 13.05 | wt % |

C) one or more latent epoxy curing agents, which is dicyandiamide;
D) one or more epoxy curing catalysts, which is tris-2,4,6-tris(dimethylaminomethyl)phenol embedded into a polyvinylphenol polymer matrix.

Bonded Substrate

The invention also provides a bonded structure comprising:
(1) a first substrate;
(2) a second substrate;
(3) an adhesive composition connecting a portion of the surface of the first and second substrates, wherein the adhesive composition comprises:
A) at least one epoxy resin;
B) from 5 to 16 wt %, based on the total weight of the adhesive, of a reactive toughener made by reacting at least one poly(alkylene oxide)diol and poly(butadiene)diol with a diisocyanate in the presence of a polyurethane catalyst, followed by chain extension with a di-phenol, and end-capping with a mono- or di-phenol;
C) one or more latent epoxy curing agents;
D) one or more epoxy curing catalysts.

In a preferred embodiment, the first and second substrates are independently selected from metals, glass, plastics and composites. Preferred metals are aluminium and steel. Preferred plastics include polyamide or epoxy based carbon fiber and glass fiber reinforced composites.

### Effect of the Invention

The adhesive compositions of the invention show excellent adhesion and mechanical characteristics after high temperature and humidity exposure (“Cataplasma test”). Specifically, lap shear specimens prepared according to DIN EN 1465-2009-07: 10×25 mm bonded area, 0.2 mm adhesive layer thickness, on 1.8 mm thick steel substrates HE 450 GI 10/10, cured in an oven at an oven temperature of 180° C. for 30 minutes, and then aged at 70° C. at 98% relative humidity for 3 weeks, 2 h at −20° C., followed by conditioning for 2 hours at 23° C./50% relative humidity, show adhesion failure of 25% or less.

### EXAMPLES

TABLE 1
List of ingredients used in adhesives of the Examples

| Ingredient | Chemistry |
|---|---|
| D.E.R. 331 | a liquid reaction product of epichlorohydrin and bisphenol A, |
| | having an epoxide equivalent weight of 182-192 g/eq (as |
| | measured according to ASTM D-1652), an epoxide percentage |
| | of 22.4-23.6% (as measured according to ASTM D-1652), an |
| | epoxide group content of 5200-5500 mmol/kg (as measured |
| | according to ASTM D-1652), and a viscosity at 25° C. of 11000- |
| | 14000 mPas (as measured according to ASTM D-445) |
| D.E.R. 671 | a solid epoxy resin is a low molecular weight solid reaction |
| | product of epichlorohydrin and Bisphenol-A, having an epoxide |
| | equivalent weight of 475-550 g/eq (as measured according to |
| | ASTM D-1652), an epoxide percentage of 7.8-9.1% (as |
| | measured according to ASTM D-1652), an epoxide group |
| | content of 1820-2110 mmol/kg (as measured according to |
| | ASTM D-1652), and a melt viscosity at 150° C. of 400-950 mPas |
| | (as measured according to ASTM D-4287) |
| *Solid-liquid epoxy resin | Semi-Solid DGEBA resin |
| mix | |
| Epoxy silane | 9-[2-(2-Methoxyethoxy)ethoxy]-9-[3- |
| | (oxiranylmethoxy)propyl]- |
| | 2,5,8,10,13,16-hexaoxa-9-silaheptadecane |
| Araldit DY-E/CH | monoglycidylether of C₁₂-C₁₄ alcohol |
| Fluorad FC 4430 | non-ionic polymeric fluorochemical surfactant |
| Dyhard 100SF | Dicyandiamide |
| Colorant | Color pigment paste |
| EP796; curing accelerator | tris-2,4,6-tris(dimethylaminomethyl)phenol embedded into |
| | a polyvinylphenol polymer matrix |
| Omya BSH | Calcium carbonate |
| Nyglos 8 | Wollastonite |
| Talk 1N | talc |
| Chaux Vive | Calcium oxide |
| K25 | Hollow glass spheres |
| Aerosil 202 | Fumed silica |

*D.E.R 671 to 331 = 40:60

D.E.R.™ 331 ™ Liquid Epoxy Resin is a liquid reaction product of epichlorohydrin and bisphenol A, having an epoxide equivalent weight of 182-192 g/eq (as measured according to ASTM D-1652), an epoxide percentage of 22.4-23.6% (as measured according to ASTM D-1652), an epoxide group content of 5200-5500 mmol/kg (as measured according to ASTM D-1652), and a viscosity at 25° C. of 11000-14000 mPas (as measured according to ASTM D-445).

D. E. R.* 671 solid epoxy resin is a low molecular weight solid reaction product of epichlorohydrin and Bisphenol-A, having an epoxide equivalent weight of 475-550 g/eq (as measured according to ASTM D-1652), an epoxide percentage of 7.8-9.1% (as measured according to ASTM D-1652), an epoxide group content of 1820-2110 mmol/kg (as measured according to ASTM D-1652), and a melt viscosity at 150° C. of 400-950 mPas (as measured according to ASTM D-4287).

TABLE 2
Ingredients for toughener used in the Examples

| Comp. | Abbreviation | Chemistry |
|---|---|---|
| a | PTMEG 2000 | Polytetrahydrofuran-diol 2000 g/mol |
| b | PBD | Polybutadiene diol 2800 g/mol |
| c | HMDI | 1,6-Hexamethylenediisocyanate |
| e | ODBA | O,O′-diallylbisphenol A |
| f | CNSL | Cardanol (phenolic lipid extracted from cashew |
| | | nutshell liquid) |
| g | DBTDL | Dibutyltin dilaurate |

Production of Toughener

The toughener was produced by the following process.
1. First reaction step: The amounts of each ingredient are listed in Table 3. Components [a] and EN were added into a lab reactor and heated up to 120° C. The mixture was mixed for 30 minutes at 120° C. under vacuum. The mixture was cooled down to 60° C. When the temperature reached 60° C. component [c] was added, and the mixture was mixed for 2 minutes. Component [g] was added, and the mixture was allowed to react at 85° C. (bath temperature) for 45 minutes under nitrogen.
2. Second reaction step: Component [e] was added and the mixture was stirred for 60 minutes at 95° C. (bath temperature) under nitrogen.
3. Third reaction step: Component [f] was added and the mixture was stirred for 90 minutes at 95° C. (bath temperature) under nitrogen. Finally, the mixture was stirred for 10 minutes at 95° C. under vacuum for degassing.

The toughener used in the Examples was synthesized using the process described above, and the ingredients listed in Table 3.

TABLE 3
Toughener A having 75 wt-% PTMEG:25 wt-% PBD (regarding
the total polyol content) 100% chain extension

| Component | Identity | Wt % |
|---|---|---|
| a | PTMEG 2000 | 50.41 |
| e | ODBA | 7.09 |
| b | PBD | 16.81 |
| c | HMDI | 12.58 |
| f | CNSL | 13.05 |
| g | DBTDL | 0.06 |
| | Total: | 100 |

TABLE 4
Comparative and Inventive adhesive compositions
TABLE 4: summarises the compositions of the adhesive formulations used in
the Examples. Inventive compositions are designated with an “E”, and
comparative compositions are designated with a “CE”.

| Formulation | CE1 | CE2 | E1 | E2 | E3 | E4 |
|---|---|---|---|---|---|---|
| Toughener A | 20.0% | 18.0% | 16.0% | 14.0% | 12.0% | 10.0% |
| D.E.R. 331 | 39.3% | 39.3% | 39.3% | 39.0% | 39.0% | 39.0% |
| *Solid-liquid epoxy resin mix | 7.9% | 9.8% | 11.6% | 13.8% | 15.7% | 17.5% |
| Araldit DY-E/CH | 0.7% | 0.7% | 0.7% | 0.7% | 0.7% | 0.7% |
| Fluorad FC 4430 | 0.3% | 0.3% | 0.3% | 0.3% | 0.3% | 0.3% |
| Epoxy silane | 0.8% | 0.8% | 0.8% | 0.8% | 0.8% | 0.8% |
| colorant | 0.5% | 0.5% | 0.5% | 0.5% | 0.5% | 0.5% |
| Dyhard 100SF | 4.2% | 4.3% | 4.5% | 4.6% | 4.7% | 4.9% |
| EP796 | 1.1% | 1.1% | 1.1% | 1.1% | 1.1% | 1.1% |
| Omya BSH | 4.0% | 4.0% | 4.0% | 4.0% | 4.0% | 4.0% |
| Nyglos 8 | 4.0% | 4.0% | 4.0% | 4.0% | 4.0% | 4.0% |
| Chaux Vive | 9.0% | 9.0% | 9.0% | 9.0% | 9.0% | 9.0% |
| K25 | 1.0% | 1.0% | 1.0% | 1.0% | 1.0% | 1.0% |
| Talk 1N | — | — | — | — | — | — |
| Fumed silica | 7.2% | 7.2% | 7.2% | 7.2% | 7.2% | 7.2% |
| Sum: | 100 | 100 | 100 | 100 | 100 | 100 |
| Epoxy/Dicy ratio | 5 | 5 | 5 | 5 | 5 | 5 |

All the inventive formulations used a reduced amount of toughener 16 wt %), as compared to the amount conventionally used. The comparative examples 1 and 2 as well as the inventive examples 1 to 4 differ only in the content of toughener. The reduced toughener content in the different formulations is compensated by liquid epoxy resin D.E.R. 331 as well as semi-solid epoxy resin mix and a modified amount of dicyandiamide to keep the epoxy dicyandiamide ratio constant (EP/Dicy ratio is calculated by the ratio of the number of epoxy groups per kg to the number of dicy molecules per kg of the formulation). Comparative examples 1 and 2 contain a high toughener content as conventionally described in prior art with 20 wt % and 18 wt % of toughener. The inventive examples 1 to 4 contain decreasing amounts of toughener from 16 wt % down to only 10 wt % respectively.

Test Methods

Rheology

Rotatory viscosity/yield stress: Bohlin CS-50 Rheometer, C/P 20, up/down 0.1-20s/1; 45° C.; evaluation according to Casson model

Thermal Analysis

Dynamic Mechanical Analysis (DMA): Glass transition temperature, T_{g}, was determined by DMA measurement and defined as the maximum of the tan δ.

Test method: Temperature range: 40° C. to +250° C.; frequency: 1 Hz; heating rate: 3° C./min

Mechanical Testing

Used steel: HE450M G10/10 thickness 1.8 mm galvanized steel ex Arcelor re-greased with Quaker Ferrocoat N6130

Lap shear strength was measured according to DIN EN 1465-2009-07: 10×25 mm bonded area, 0.2 mm adhesive layer thickness

Impact peel strength was measured according to BS EN ISO 11343:2005: 20×30 mm bonded area, 0.2 mm adhesive layer thickness used steel: DX56 Z100 0.8 mm

Modulus was measured according to DIN EN ISO 527-1:2012

Failure Mode Rating
CF=cohesive failure
AF=adhesion failure
100=100% failure

Humidity exposure test (“Cataplasma test”) was performed according to RNES-B-00137 v1.0, using the following lap shear specimens:

Lap shear specimens were prepared by applying the respective adhesive formulation according to RNES-B-00058 v1.0, using the substrates described above and the given bonding area dimension followed by curing of the specimens in an oven (oven temperature) at temperatures and times as written in the tables (30 minutes 180° C.). The specimens were then aged at 70° C. at 98% relative humidity for 3 weeks, 2 h at −20° C., followed by conditioning for 2 hours at 23° C./50% relative humidity.

Table 5 summarises rheology, mechanical and bulk property data and the results of the humidity exposure testing. The failure mode is analysed and rated.

TABLE 5
Rheology, mechanical and bulk properties of adhesives

| Formulation | CE1 | CE2 | E1 | E2 | E3 | E4 |
|---|---|---|---|---|---|---|
| Toughener content | 20.0% | 18.0% | 16.0% | 14.0% | 12.0% | 10.0% |
| Rheology | | | | | | |
| Viscosity, Casson, 45° C. [Pas] | 42 | 37 | 26 | 24 | 26 | 17 |
| Yield stress, Casson, 45° C. [Pa] | 441 | 467 | 567 | 552 | 530 | 566 |
| Bulk properties | | | | | | |
| Elastic Modulus [MPa] | 2260 | 2520 | 2550 | 2830 | 2930 | 3100 |
| Elongation [%] | 4.3 | 4.1 | 3.7 | 3.5 | 3.6 | 3.8 |
| Tensile Strength [MPa] | 34 | 37 | 39 | 43 | 43 | 48 |
| Lap shear strength [MPa] | | | | | | |
| Initial H0 | | | | | | |
| 30′/180° C.; galva ex Etalon 1.8 | | | | | | |
| mm; HE450M 10/10 | | | | | | |
| Failure mode | | | | | | |
| Exposure test: | 12.1 | 12.8 | 14.1 | 16.0 | 17.2 | 17.5 |
| Cataplasma H21: | | | | | | |
| 30′/180° C.; galva ex Etalon 1.8 | | | | | | |
| mm; HE450M 10/10 | | | | | | |
| Adhesion Failure in % | 40% | 35% | 25% | 20% | 25% | 25% |
| Corrosion | — | — | — | — | — | — |
| Dynamic mechanical Analysis | | | | | | |
| Glass transition temperature [C.] | 109.1 | 112.2 | 115.3 | 117.1 | 119.1 | 120.7 |
| Impact peel strength [N/mm] | | | | | | |
| DC56 + Z100; 23° C. | 28 | 27 | 25 | 24 | 24 | 21 |

Surprisingly, when the toughener content is decreased, an impressive reduction in percentage of adhesion failure is observed after humidity and heat exposure.

It can be seen that with decreasing content of toughener the elastic modulus increases from 2260 MPa up to as high as 3100.

The same is the case with the glass transition temperature which increases from 109.1° C. to 120.7° C. when the toughener content is reduced from CE1 to E4.

The impact peel strength is slightly reduced from 28 N/mm down to 21 N/mm from CE1 to inventive E4.

While certain of the preferred embodiments of the present invention have been described and specifically exemplified above, it is not intended that the invention be limited to such embodiments. Rather, it is to be understood that even though numerous characteristics and advantages of the present invention have been set forth in the foregoing description, together with details of the structure and function of the invention, the disclosure is illustrative only, and changes may be made in detail, especially in matters of shape, size and arrangement of parts within the principles of the invention to the full extent indicated by the broad general meaning of the terms in which the appended claims are expressed.

1. A one-component epoxy adhesive composition comprising:
A) at least one epoxy resin;
B) from 5 to 16 wt %, based on the total weight of the adhesive, of a reactive toughener made by reacting at least one poly(alkylene oxide)diol and poly(butadiene)diol with a diisocyanate in the presence of a polyurethane catalyst, followed by chain extension with a diphenol, and end-capping with a mono- or diphenol;
C) one or more epoxy curing agents;
D) one or more epoxy curing catalysts.

2. The adhesive composition of claim 1, wherein the at least one epoxy resin comprises a combination of liquid and solid epoxy resins.

3. The adhesive composition of claim 1, wherein the at least one epoxy resin comprises an epoxy resin selected from:
(1) a liquid reaction product of epichlorohydrin and bisphenol A, having an epoxide equivalent weight of 170-195 g/eq (as measured according to ASTM D-1652), an epoxide percentage of 22.4-23.6% (as measured according to ASTM D-1652), an epoxide group content of 5200-5500 mmol/kg (as measured according to ASTM D-1652), and a viscosity at 25° C. of 4000-14000 mPas (as measured according to ASTM D-445);
(2) a solid epoxy resin is a low molecular weight solid reaction product of epichlorohydrin and Bisphenol-A, having an epoxide equivalent weight of 475-550 g/eq (as measured according to ASTM D-1652), an epoxide percentage of 7.8-9.1% (as measured according to ASTM D-1652), an epoxide group content of 1820-2110 mmol/kg (as measured according to ASTM D-1652), and a melt viscosity at 150° C. of 400-950 mPas (as measured according to ASTM D-4287); and
(3) mixtures of these.

4. The adhesive composition of claim 1, wherein the toughener comprises a poly(alkylene oxide)diol selected from poly(C₂-C₆ alkylene oxide) diols.

5. The adhesive composition of claim 1, wherein the toughener comprises a poly(alkylene oxide) diol selected from poly(tetramethylene oxide)diol (“PTMEG”), poly(trimethylene oxide)diol (“PO3G”), and mixtures of these.

6. The adhesive composition of claim 1, wherein the toughener comprises a poly(alkylene oxide) diol that is PTMEG, having a molecular weight of in the range of 1,000 to 2,500 Da, more preferably 2,000 Da.

7. The adhesive composition of claim 1, wherein the diisocyanate is an aliphatic diisocyanate.

8. The adhesive composition of claim 1, wherein the diisocyanate is HMDI.

9. The adhesive composition of claim 1, wherein the PBD has a molecular weight in the range of 2,000 to 3,500 Da, more preferably 2,800 Da.

10. The adhesive composition of claim 1, wherein chain extension of the toughener is carried out with O,O′-diallylbisphenol A (“ODBA”).

11. The adhesive composition of claim 1, wherein end-capping of the toughener is carried out with cashew nut shell oil (“CNSL”).

12. The adhesive composition of claim 1, wherein the toughener is present at 14 wt % or less, based on the total weight of the adhesive composition.

13. The adhesive composition of claim 1, wherein the toughener is present at 12 wt % or less, based on the total weight of the adhesive composition.

14. The adhesive composition of claim 1, wherein the toughener is present at 10 wt % or less, based on the total weight of the adhesive composition.

15. The adhesive composition of claim 1, wherein lap shear specimens prepared according to DIN EN 1465-2009-07: 10×25 mm bonded area, 0.2 mm adhesive composition layer thickness steel substrates HE 450 GI 10/10, cured in an oven at an oven temperature of 180° C. for 30 minutes, and then aged at 70° C. at 98% relative humidity for 3 weeks, 2 h at −20° C., followed by conditioning for 2 hours at 23° C./50% relative humidity, show adhesion failure of 25% or less.

16. A bonded structure comprising:
(1) a first substrate;
(2) a second substrate;
(3) an adhesive composition bonding a portion of the surface of the first and second substrates, wherein the adhesive composition is according to claim 1.

17. A bonded structure according to claim 16, wherein the first and second substrates are selected from aluminium, steel, polyamide and epoxy-based carbon fiber and glass fiber reinforced composites.
